(19) United States
(12) Patent Application Publication
(10) Pub. No.: US 2010/0138613 A1
(43) Pub. Date: Jun. 3, 2010

(54) Data Caching

(75) Inventor: Jason Parker, London (GB)

Correspondence Address: Nokia, Inc., 6021 Connection Drive, MS 2-5-520, Irving, TX, 75039, US

(73) Assignee: Nokia Corporation, Espoo, FL (US)

(21) Appl. No.: 12/489,404

(22) Filed: Jun. 22, 2009

(30) Foreign Application Priority Data
Jun. 20, 2008 (GB) 0811422.5

(51) Int. Cl. G06F 12/08; G06F 12/00

(52) U.S. Cl. 711/133; 711/118; 711/E12.001; 711/E12.022; 711/E12.017

(57) ABSTRACT

The invention relates to a method for improving caching efficiency in a computing device. It utilises metadata, that describes attributes of the data to which it relates, to determine an appropriate caching strategy for the data. The caching strategy may be based on the type of the data, and/or on the expected access of the data.

### RELATED APPLICATION

This application was first filed and claims priority to Great Britain Application No. 0811422.5 filed on 20 Jun. 2008.

### FIELD OF THE INVENTION

Examples of the present invention relate to caching data. Particular examples relate to a method for managing a cache using metadata.

### BACKGROUND TO THE INVENTION

In the field of computing, the concept of a memory hierarchy is well known. Memory at the top of the hierarchy is used for temporary storage of code or data that is being processed by a central processing unit (CPU). Such memory is typically very expensive to manufacture, but allows very fast access by a CPU. On the other hand, memory at the bottom of the hierarchy is used for longer-term storage of data, and it tends to be less costly but much slower for a CPU to access.

### SUMMARY OF THE INVENTION

According to a first example of the present invention there is provided an apparatus comprising: at least one processor; and at least one memory including computer program code; the at least one memory and the computer program code configured to, with the at least one processor, cause the apparatus at least to perform: receiving an instruction to access a set of data; retrieving metadata associated with the set of data; in dependence on the metadata, determining a caching strategy for the set of data; and enabling the requested access to the set of data by implementing the caching strategy.

According to a second example of the present invention there is provided a method comprising: receiving an instruction to access a set of data; retrieving metadata associated with the set of data; in dependence on the metadata, determining a caching strategy for the set of data; and enabling the requested access to the set of data by implementing the caching strategy.

According to a third example of the present invention there is provided an apparatus comprising at least one processor; and at least one memory including computer program code; the at least one memory and the computer program code configured to, with the at least one processor, cause the apparatus at least to perform: analysing a set of data to determine characteristics of the set of data; and in dependence on the determination, producing metadata indicating a cachability attribute of the set of data.

According to further examples of the invention there may be provided a memory management unit for implementing the method described above.

Examples of the invention may be implemented in software or in hardware or in a combination of software and hardware. Embodiments of the invention may be provided as a computer program or a computer program product.

The one or more processors of embodiments of the invention may comprise but are not limited to (1) one or more microprocessors, (2) one or more processor(s) with accompanying digital signal processor(s), (3) one or more processor(s) without accompanying digital signal processor(s), (3) one or more special-purpose computer chips, (4) one or more field-programmable gate arrays (FPGAS), (5) one or more controllers, (6) one or more application-specific integrated circuits (ASICS), (7) one or more combination of hardware/firmware, or (7) one or more computer(s). The apparatus may include one or more memories (e.g., ROM, RAM, etc.), and the apparatus is programmed in such a way to carry out the inventive function.

### DESCRIPTION OF THE DRAWINGS

Example embodiments of the invention will now be described in detail by way of example, with reference to the accompanying drawings in which:

FIG. 1 depicts the structure of an example memory hierarchy;

FIG. 2 is a flow chart showing an entry being written to cache in accordance with an example embodiment of the invention;

FIG. 3 is a schematic layout of components in an example smartphone; and

FIG. 4 is a flow chart representing another embodiment of the invention.

### DETAILED DESCRIPTION OF EXAMPLE EMBODIMENTS OF THE INVENTION

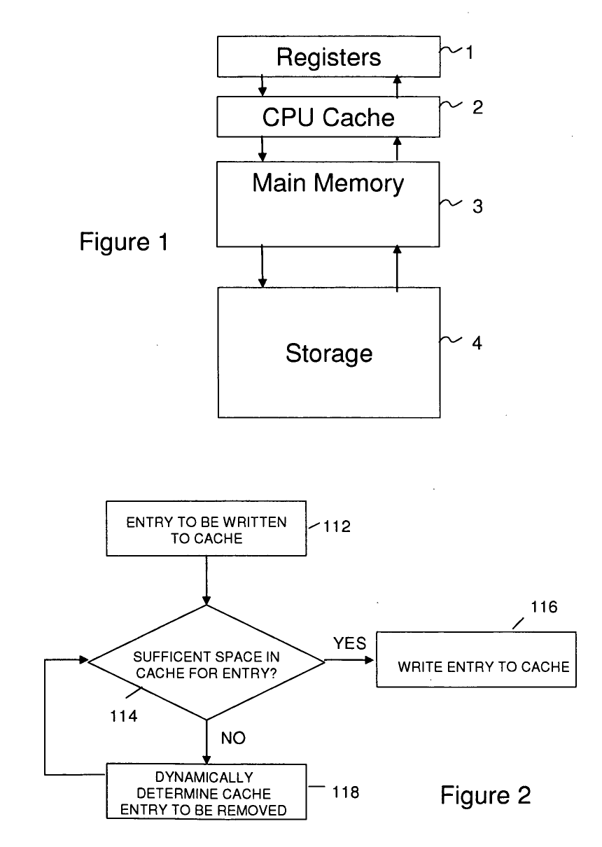

FIG. 1 shows an example of a memory hierarchy. The registers 1 are the fastest memory available to the computer. They are used to temporarily store the instructions and data being operated on by the CPU. Often only a very small amount of register memory is provided in a computing device.

Next in the hierarchy is a CPU cache 2. This is a relatively small region of randomly accessible memory, often provided on the same chip as the CPU. Due to its proximity to the CPU, data stored in the CPU cache can be accessed relatively quickly. The CPU cache acts as a buffer between the high speed at which the processor can execute instructions, and the relatively low speed at which data or instructions can be retrieved from memory lower down in the hierarchy.

Below the CPU cache in the hierarchy is the main memory 3. This is a relatively large area of randomly accessible memory, which is typically less expensive than either register or CPU cache memory. It is external to the CPU chip, and is used to hold program code while the program is executing on the CPU, and data that is related to the program being executed.

Below the main memory in the memory hierarchy is storage memory 4. This is typically the cheapest form of memory on a computer, and is used to permanently store data and program code such as the computer's operating system, system data, user data and installed applications. Accessing data or code from storage memory tends to be a relatively slow operation, partly because of the inherent properties of the memory types used for permanent storage, and partly because of the number of components that lie physically between the storage memory and the CPU, which tend to introduce delays since the interfaces are relatively slow.

Registers, CPU cache and main memory all tend to be volatile memory types, meaning that they can only store data while they are being supplied with power. Storage 4, on the other hand, is usually non-volatile, so that it retains its contents after the power source is removed from the computer.

Although the basic arrangement of types of memory in any computing device will often conform to this hierarchy, the precise structure of the memory in a particular device will depend on the purpose for which the device is intended. A desktop computer, for example, may have registers, multiple levels of CPU cache of varying speeds and proximities to the CPU, a large area of main memory, a permanently connected hard drive for storage, and various removable, or external, storage devices such as CDs, DVDs or USB memory devices. A smaller device such as a smartphone may have a different arrangement—for example, fewer levels of CPU cache, a smaller main memory, and a NAND Flash device in place of a hard drive.

No matter what the precise arrangement of memory within a device, it is generally the case that data can be copied between layers in the memory hierarchy according to the intended usage of the data at a given time. For example, photograph data stored on a removable memory card in a smartphone can be copied from the card into main memory to increase the speed at which the data can be read by the CPU, and thus to reduce the delay experienced by a user wishing to view the photographs. Similarly, data can be passed down the hierarchy when it has been written by the CPU. For example, the copy of the data in main memory will be written to storage memory, and the version in main memory can then be marked for deletion.

Copying data from a lower level in a memory hierarchy to a higher level, in order to facilitate access by a CPU, is referred to as caching. In one example, the term “cache” refers to a region of memory for holding data to allow the data to be more quickly accessed by a processor.

In several examples of computing device operations, when an item of data is needed by a process operating on the device, the process can proceed more quickly if the required data is higher up the memory hierarchy. For example, if the data is already held in a register, the CPU can read or operate on the data very quickly. If it is in a CPU cache, then the data can be passed quickly into a register and then read or operated on. If it is in main memory, it can be copied as needed into a CPU cache, and from there it can be passed to a register for access by the CPU. If it is in storage memory—particularly external storage—then access can be very slow: first the data will be copied into main memory, either in one operation or in a series of smaller operations; it will then be copied as needed into a CPU cache, and finally into a register before being read or operated on by the CPU. Since access speeds increase down the layers in a memory hierarchy, a process that requires data will generally start looking for data at the top of the hierarchy. Thus, if the required data is not already in a register, a check will be made to see if that data is in a CPU cache. If it is, then time can be saved since the data does not need to be retrieved from the relatively slow main memory or storage memory. If the required data is not in a CPU cache, then the main memory will be checked; and finally, if the data is not in main memory, it will be retrieved from storage memory.

The operation of attempting to locate data in a cache and successfully finding it there is known as a “cache hit”. A “cache miss”, on the other hand, occurs when the data required by a process cannot be found in a cache. The ratio of cache hits to the total number of data accesses is known as the “hit ratio” or “hit rate”. Hit rates of 90% or higher are typical, and in general the higher the cache hit rate in a computing system, the better the performance of the system. There is therefore a general desire in the computing industry to find ways of improving cache hit rates.

Memory management units (MMUs) are used in computing systems to track the contents of the various memory devices in use, and to translate between the physical addresses representing the actual location within a piece of physical memory at which particular data is stored, and the corresponding virtual or logical addresses that are used by processes wishing to access the data.

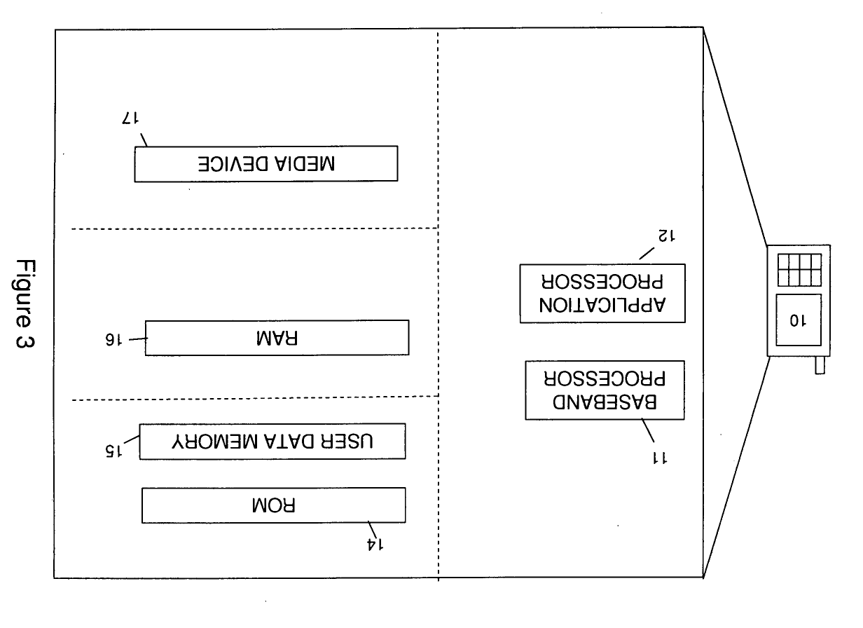

It will often be the MMU of a computer that will perform a check to determine whether a particular required item of data is held in a CPU cache or in main memory. If the data is not already present in such a location, an operation will be performed to copy the data into cache memory. Since the faster memory in a device is limited in size due to limitations on cost and physical size, it may be the case that no space is currently available in cache memory for new data to be copied in. An example scenario is shown in FIG. 2. In block 112, a determination is made that an item of data is to be written to cache. In block 114 a check is made as to whether sufficient space is currently available in the cache for the new entry. If yes, the entry is written to cache (block 116); if no, an existing item of data in the cache must first be discarded (block 118) to free sufficient space for the new entry so that it can then be written to cache (block 116).

It can be seen from this example that there is sometimes a need to select a particular item or items for deletion from cache before new data can be copied into cache. A common technique for managing cache is to monitor the most recent time when a particular item of data in the memory was used, and to mark for deletion the item that is least recently used. An algorithm for operating this scheme is known as an LRU algorithm. It tends to ensure that data that is still likely to be required in cache is retained, while data that is less likely to be needed can be removed to provide space for new data to enter the cache. However, past usage of data is not always representative of future usage, so LRU algorithms cannot perfectly predict which data can most conveniently be removed. An improved mechanism is therefore desirable for predicting which data is most likely to be usefully located in a cache at any given time.

FIG. 3 illustrates various component parts of a smartphone 10, which will be used as the basis for a detailed description of an example implementation of the present invention. Two processors are shown, for handling different types of data processing operations. A baseband processor 11 handles data transmitted from and received by the smartphone over a radio frequency data link; it contains code needed for controlling telephony operations on the smartphone. An applications processor 12 handles the other operations of the smartphone. It includes a CPU, on-chip memory, an MMU, interfaces to various items of hardware, and many other elements.

Also in the example smartphone is a relatively large region of memory that appears to software applications as read-only memory (ROM) 14; this contains the operating system (OS) and system data. User data memory 15 can be provided as part of the same piece of physical memory as the ROM. On Symbian smartphones, for example, user data, the OS and system data are all stored in flash memory, but the region of memory that holds the OS and the system data is controlled such that it cannot be overwritten.

A region of randomly accessible memory (RAM) 16 is provided, that is used as the main working memory of the device. Parts of the OS are copied into the RAM when the device is running, and data used by any running processes is copied or written into the RAM as needed.

Finally, a media device 17 is shown. This could for example be a Secure Digital (SD) card which can be inserted into a slot provided in the phone, and removed when required. User data or downloaded applications can be stored on the media device.

In this example, in order that any data or program code stored in a storage device can be easily retrieved by a user or an application when required, the data is held in a file system. In the example, a file system is an abstract, organised hierarchy of files and directories into which individual sets of data can be placed in a logical manner. Users or applications can create file names to identify individual sets of data, and directory names for logically grouping together files.

Metadata can be logically attached to items of data in the file system of this example. The metadata describes characteristics of the data to which it relates. The metadata can include the name of a file, its size, the type of the file (for example, a Microsoft Word® document (.doc), or an image such as a Portable Document Format document (.pdf)), and information concerning users of the file (such as author information, and the “last modified” date). Embodiments of this invention can provide a new use of the concept of metadata, to determine how to cache the data to which it pertains.

In a first example embodiment of the invention, a user of a smartphone has downloaded various MP3 music files onto his device and stored them in the device's file system in a directory named “Music”, and a sub-directory named “Favourite albums”. The files are stored on a removable mini SD card 17. Since access by the CPU of files on the removable card is relatively slow in this example, the device is configured to copy data into main memory before it is required by the CPU. Thus, when the user selects a particular album to play, the corresponding files will be loaded into memory 16 so that they can more quickly be read. First, a cache controller of the file server of the device's operating system analyses the file data to check for any metadata that could help the file server to determine a caching strategy for the files. The selected album has been recently downloaded and stored, and has not yet been accessed by the user, no relevant metadata is found. As a result, the cache controller begins an analysis of the content of the requested files. It determines that the content is MP3 music files, and determines the size of each file. The cache controller also determines that the requested file data includes header information that identifies the artist's name, the name of the selected album, and the name and length in time of each track within the album.

In this embodiment the cache controller is provided as an extension of a standard file server cache component in a computing device. It is provided in accordance with the first embodiment to generate and handle metadata that provides information relating to caching efficiency for particular items of data. An additional level of intelligence is thereby provided in the file server software, with a view to improving the cache hit rate of the device and improving its file reading performance.

In the first example embodiment, having analysed the music files selected by the user, the cache controller uses a look-up table to generate metadata that indicates the following:

| | |
|---|---|
| Album header information specifying artist | ReadHeaders |
| name and album name | |
| Header information of individual tracks, | ReadHeaders |
| including track name and track length | |
| Main content of music files | ReadAhead; |
| | ReadDiscard |

The metadata is placed in the device's memory 16 so that it is available while the music files are being played. It indicates to the cache controller that:
(i) The album header information is likely to be required by the user for as long as the user is listening to the album. This information should be read into memory and should remain there until the user stops playing the album;
(ii) The header information for individual tracks is likely to be required by the user for as long as the user is listening to the album. This information should be read into memory and should remain there until the user stops playing the album;
(iii) The music files contain data that is expected to be read sequentially. This data should be sequentially read into memory in advance of its expected play-out time (ReadAhead);
(iv) The music files contain data that is not expected to be needed again after it has been played out to the user. This information can be removed from memory, or marked for re-use, after it has been read by the CPU (ReadDiscard).

In accordance with the caching strategy recommendations in the metadata of this example, the cache controller reads data into memory and discards it from memory in an efficient manner. Points (i) and (ii) ensure that fast access to the header information will be possible until the user selects a track outside of the album, or closes the music player application, at which time the data can be marked by the MMU for deletion. Point (iii) improves the efficiency of fetching the data from the external storage device 17. Reading ahead is a technique for improving file reading performance, involving reading blocks of data into memory in advance of an expected requirement for those blocks. In this example it aims to ensure that the music data is immediately available when it is needed by the CPU, and it aims to save the time taken to actively fetch the data for a particular section of a particular track as that section is to be played out. Point (iv) aims to clear the cache 16 of data that is not expected to be needed by the CPU. This helps to ensure that when the music player application, or any other application running on the device, wishes to place program code or data into the memory, space will be available. Power savings can also be made, by avoiding unnecessary removals of data from memory and subsequent re-reads.

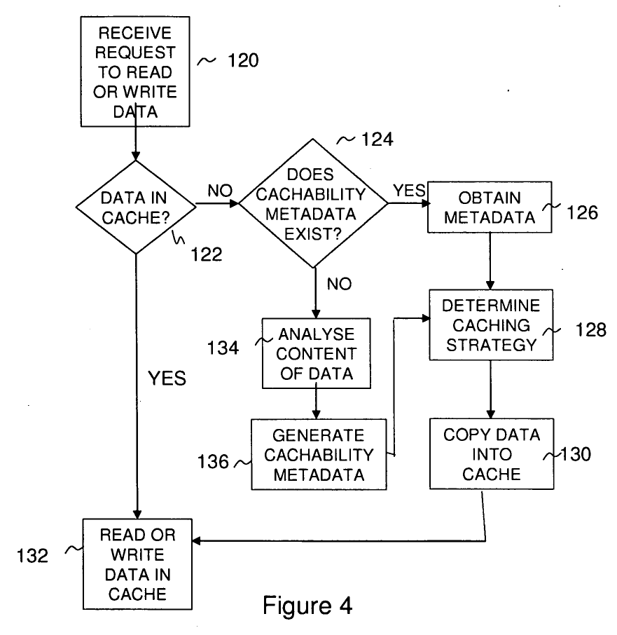

The operations performed by the file server in the first example embodiment are summarised in FIG. 4. At block 120, the cache controller is notified that data is required by the CPU. The notification includes an indication of the location in storage memory 17 of the required data. At block 122, the MMU is used to check whether the required data is already present in cache memory—in this case, main memory 16. If the data is already in the cache, then it can be read by the CPU. In this embodiment, no further steps are then taken, because it is assumed that the cache controller of the file server already has knowledge of the cachability attributes of the data, as these would have been determined when the data was read into the cache.

If the data is not already present in the cache, then a check is made (block 124) as to whether metadata indicating the cachability of the data is present in the data structure of the file system. If it is, then the metadata is retrieved (block 126) and read into memory so that it can be accessed while the cache controller is controlling the reading or discarding of the data into or from the memory. The metadata thus obtained is used to determine a caching strategy (block 128) for the data, and the data is copied into cache (block 130) in accordance with that strategy.

If no metadata exists for the required data then the content of the data is analysed by the cache controller (block 134) and cachability metadata is generated (block 136). This metadata is then read into memory and used to determine a caching strategy (block 128). Finally, the data is copied into memory (130) in accordance with the caching strategy, from where it can be read by the CPU.

In this first example embodiment, once the cachability metadata has been generated by the cache controller of the file system, it is saved in the file system in association with the music data to which it relates and tagged to label it as cachability metadata. This enables the caching strategy for the music data to be determined more quickly the next time the music files are accessed by the user: the cachability metadata can simply be copied into memory, and read by the cache controller as needed.

In a second example embodiment of the invention, a cache controller performs some of the same steps described above in relation to the first embodiment, but this time the metadata used to determine a caching strategy is simply pre-existing metadata specifying certain standard characteristics of the data such as its type, its size and so on. The cache controller retrieves this descriptive metadata and uses a look-up table to determine a caching strategy for the data. The look-up table specifies cachability attributes for different kinds of data. As described in relation to the first embodiment above, when sequential reading of data is considered likely, ReadAhead and ReadDiscard may be a convenient tactic for caching the data, and the look-up table indicates this. It also indicates that data that is expected to be accessed in a random pattern should be read into cache and retained. For example, the contents of a database are likely to be accessed randomly and for an extended period, so the database contents should be read into memory and retained there until the process requiring access terminates, for example, or until no database content has been accessed for a predetermined period of time.

In the same way as has been described for the reading of data by the CPU, caching strategies for writing data can be provided in the look-up table. Thus, depending on the type of data being written, when a process is writing data to memory the data is held in memory for an appropriate length of time until it can be written out to storage memory. In a device that aims to preserve the integrity of data that is considered to be critical, the length of time that the data remains in cache can be set according to the perceived importance of the data. For example, image data representing a photograph taken by a camera on the smartphone 10 could be deemed relatively unimportant. A relatively long cache time could be set for such data, thus introducing a risk that if power is unexpectedly removed from the cache memory while the data is held there, for example due to a user dropping the phone such that the battery is dislodged, or due to the battery running out of power, the image data will be lost irretrievably. On the other hand, a new address just entered by a user into the smartphone could be deemed relatively important. For such data a short cache time could be set, so that the data will not remain in cache for long before it is written to non-volatile memory 15. The risk that this data will be lost due to an unexpected sudden removal of power is therefore lower than for the less important data.

It will be understood that the details of the caching tactics indicated in the look-up table can be customised according to the system on which the table is intended to be used. The level of detail provided in the table, both regarding the indication of data or file types and regarding the specification of caching tactics, can be adjusted according to the level of sophistication required. A more detailed table will incur a greater delay since look-up times will be longer, but it might be capable of providing greater performance enhancements than a more basic table. These factors need to be balanced when the table is being created.

In a third example embodiment, data that is to be stored in the file system on the ROM 14 of the smartphone is analysed prior to its storage on the ROM. The contents of the file system are statically analysed during the process of building the ROM, and from the analysis file characteristics such as type, contents and dependencies are determined. Cachability metadata is generated on the basis of the file characteristics, with the aid of a table linking the file characteristics to cachability attributes based on expected access patterns for the data. The metadata is then added to the file system data structure for use at runtime when the file system contents are to be read into memory 16.

In a fourth example embodiment, the invention is applied to data retrieved from a remote resource such as an internet server. Web-based Distributed Authoring and Versioning (WebDAV) enables multiple users to share and edit files held in a single location on a server. In this embodiment, when a user of the smartphone 10 wishes to read or write data from a WebDAV file system, the content is analysed by the cache controller on the smartphone, and expected usage patterns are determined from the analysis. Cachability metadata is generated dynamically, and held in memory while the remote server is being accessed.

It will be understood that embodiments of the invention can be applied to program code as well as to data in file systems. For example, program code that forms a part of a device's operating system could be statically analysed so that dependencies and expected access patterns can be determined, and from this recommendations can be generated as to how best to cache the code when it is required. The boot time of a device could be reduced in this way if the usage of code could accurately be determined from an analysis of the code.

It will also be understood that the smartphone 10 has been described as an example device on which the invention could be implemented; the invention is equally applicable to any other suitable type of device, such as one that has multiple layers of memory having differing access speeds.

It will further be appreciated that any cachability metadata, whether it is specifically generated for the purpose of an embodiment of this invention or whether it exists for another purpose and is used in accordance with embodiments of this invention to ascertain an appropriate caching strategy, could be held in the file system for the duration of the file system access rather than being loaded into memory for faster access. This could have the advantage of keeping more memory free for use by processes running on the device, but would have the disadvantage that it could introduce additional latency into caching decisions since metadata in the file system data structure would need to be accessed each time a caching decision was required.

An alternative embodiment of the invention could engage the cache controller to analyse any new files being added to the file system at the time when they are stored, to analyse the data and generate cachability metadata at that time to be stored together with the files.

It will be understood by the skilled person that alternative implementations are possible in addition to those described in detail above, and that various modifications of the methods and implementations described above may be made within the scope of the invention, as defined by the appended claims.

Within some embodiments of the invention, by providing a further level of intelligence to caching decisions, improvements in cache hit rates can be obtained and thus the speed of operation (performance) of the computing device can be improved.

In some embodiments, a decision may be taken prior to beginning caching behaviour that a set of data should not be cached at all, and this may have various technical effects including saving a copy operation at the side of a process requesting access to the set of data, thereby potentially reducing processing overhead and saving memory space at the process side. By performing some level of analysis of the cachability of the set of data at the start of a caching procedure, some embodiments can also avoid the need to analyse cache content after data has been copied into cache memory. This can provide a different technical effect compared with some prior art arrangements in which it may be necessary to analyse access patterns for various data held in a cache memory, or to perform an analysis of characteristics of data held in a cache memory, in order to determine which items of data held in a cache memory may be deleted first when space is required.

The metadata in some embodiments of the invention could indicate the type of the set of data (such as whether it is a music file, a video file, an image file or a database, for example). It could additionally or alternatively indicate a prediction of how the set of data is likely to be accessed by the processor. This could be based on the type of the set of data.

The set of data could be stored on a data storage medium, and the metadata could be stored in association with the set of data, optionally on the same medium. This arrangement could be particularly appropriate for use with data that is stored permanently on the device at the time when the device is manufactured—the metadata could be pre-produced, and stored together with the set of data.

In some embodiments, if no relevant metadata exists when the set of data is to be copied into cache memory, metadata can be provided dynamically to assist with caching decisions.

The metadata that is produced dynamically could then be stored in association with the set of data. Alternatively, the set of data could be analysed, and the metadata could be produced, each time the set of data is to be loaded into the cache. The set of data could suitably be stored within a file system on the computing device.

Various modifications, including additions and deletions, will be apparent to the skilled person to provide further embodiments, any and all of which are intended to fall within the appended claims. It will be understood that any combinations of the features and examples of the described embodiments of the invention may be made within the scope of the invention.

1. An apparatus comprising:
at least one processor; and
at least one memory including computer program code;
the at least one memory and the computer program code configured to, with the at least one processor, cause the apparatus at least to perform:
receiving an instruction to access a set of data;
retrieving metadata associated with the set of data;
in dependence on the metadata, determining a caching strategy for the set of data; and
enabling the requested access to the set of data by implementing the caching strategy.

2. An apparatus according to claim 1, wherein the at least one memory and the computer program code are configured to, with the at least one processor, cause the apparatus at least to decide, in dependence on the determined caching strategy, whether to load the set of data into a cache memory.

3. An apparatus according to claim 1 wherein the caching strategy specifies at least one of:
rules specifying whether to load the set of data, or at least part of the set of data, into a cache memory;
rules for how to manage the set of data, or at least part of the set of data, while in a cache memory;
a duration for which the set of data, or at least part of the set of data, is to be retained in a cache memory.

4. An apparatus according to claim 1 wherein the metadata indicates the type of the set of data.

5. An apparatus according to claim 1 wherein the metadata indicates a prediction of how the set of data is likely to be accessed within the apparatus.

6. An apparatus according to claim 1 wherein the at least one memory and the computer program code are configured to, with the at least one processor, cause the apparatus at least to perform: generating the metadata in dependence on an analysis of the set of data, or an analysis of further metadata associated with the set of data.

7. An apparatus according to claim 6 wherein the at least one memory and the computer program code are configured to, with the at least one processor, cause the apparatus at least to perform: storing the metadata on the apparatus in association with the set of data.

8. An apparatus according to claim 1 wherein the set of data is a data file.

9. An apparatus according to claim 8 wherein the data file is stored within a file system on the apparatus.

10. A method comprising:
receiving an instruction to access a set of data;
retrieving metadata associated with the set of data;
in dependence on the metadata, determining a caching strategy for the set of data; and
enabling the requested access to the set of data by implementing the caching strategy.

11. A method according to claim 10 further comprising:
in dependence on the determined caching strategy, deciding whether to load the set of data into a cache memory.

12. A method according to claim 10 wherein the caching strategy specifies at least one of:
rules specifying whether to load the set of data, or at least part of the set of data, into a cache memory;
rules for how to manage the set of data, or at least part of the set of data, while in a cache memory;
a duration for which the set of data, or at least part of the set of data, is to be retained in a cache memory.

13. A method according to claim 10 wherein the metadata indicates the type of the set of data.

14. A method according to claim 10 wherein the metadata indicates a prediction of how the set of data is likely to be accessed within the apparatus.

15. An apparatus comprising
at least one processor; and
at least one memory including computer program code;
the at least one memory and the computer program code configured to, with the at least one processor, cause the apparatus at least to perform:
analysing a set of data to determine characteristics of the set of data; and
in dependence on the determination, producing metadata indicating a cachability attribute of the set of data.

16. An apparatus according to claim 15 wherein the characteristics include the type of the data.

17. An apparatus according to claim 15 wherein the characteristics include a predicted usage of the data.

18. An apparatus according to claim 15 wherein the metadata indicates at least one of: the type of the data file; the size of the data file.

19. An apparatus according to claim 15 metadata indicates at least one of the following:
rules for loading the set of data into a cache memory;
rules for discarding the set of data from a cache memory;
rules for whether or not to copy the set of data, or at least part of the set of data, into a cache memory;
rules for the handling of the set of data, or at least part of the set of data, in a cache memory; and
a duration for which the set of data, or at least part of the set of data, should be retained in a cache memory.

20. A computer program or suite of computer programs for implementing the method of claim 10.
